(19) United States
(12) Patent Application Publication
(10) Pub. No.: US 2025/0286371 A1
(43) Pub. Date: Sep. 11, 2025

(54) METHOD FOR ELIMINATING FAILURE IN ALTERNATING CURRENT BUS OF ENERGY STORAGE POWER STATION

(71) Applicant: Shanghai Investigation, Design & Research Institute Co., Ltd., Shanghai (CN)

(72) Inventors: Yu LIU, Shanghai (CN); Jiayong ZOU, Shanghai (CN); Yang SHEN, Shanghai (CN); Wuqing WEI, Shanghai (CN); Ming SHI, Shanghai (CN); Shuguang XIANG, Shanghai (CN); Zhixuan PAN; Fan TONG, Shanghai (CN)

(73) Assignee: Shanghai Investigation, Design & Research Institute Co., Ltd., Shanghai (CN)

(21) Appl. No.: 18/574,326

(22) PCT Filed: Mar. 3, 2023
(86) PCT No.: PCT/CN2023/079607

§ 371 Date: Apr. 3, 2025

(30) Foreign Application Priority Data
Jun. 22, 2022 (CN) 202210713320.6

(51) Int. Cl. H02J 3/00; H02H 7/22

(52) U.S. Cl. CPC H02J 3/001; H02H 7/222

(57) ABSTRACT

A method for isolating failure in an alternating current bus of an energy storage power station includes: when a fault occurs on the alternating current bus, controlling all non-energy storage circuit breakers to trip and break and transmitting a protective signal to a coordination controller PMS by a bus protection device; upon receiving the protective signal, controlling all energy storage inverters PCS to perform power regulation and adjusting their power to 0 by the coordination controller PMS; controlling an energy storage circuit breaker to trip and break, thereby completing isolation of the fault of the alternating current bus. This method effectively avoids insulation damage to the devices and serious faults caused by the breaking overvoltage of the energy storage circuit breaker due to the capacitive inactive power emitted by the energy storage system when a bus fault occurs.

### FIELD OF THE INVENTION

The present disclosure relates to the technical field of bus protection, in particular to a method for isolating failure in an alternating current bus of an energy storage power station.

### BACKGROUND OF THE INVENTION

At present, when a fault occurs on the alternating current bus of an energy storage power station, it is necessary to isolate the faulty bus timely. The traditional method of isolating the faulty bus is to control all the circuit breakers on the bus to trip and break when the bus protection device detects a fault. However, during the process of tripping and breaking of circuit breakers, if the energy storage system supplies capacitive inactive power to the alternating current bus, the vacuum circuit breaker (i.e., the energy storage circuit breaker) on the energy storage branch is prone to produce reignition overvoltage, which may lead to the failure of the tripping of the circuit breaker on the energy storage branch and damage the insulation of the equipment, resulting in serious faults.

### SUMMARY OF THE INVENTION

The present disclosure provides a method for isolating failure in an alternating current bus of an energy storage power station. By coordinating the bus protection device and the coordination controller PMS, this method first controls all non-energy storage circuit breakers to trip and break, and transmits the protective signals to the coordination controller PMS to regulate the power of the energy storage inverter PCS to zero. Then, the energy storage circuit breaker is controlled to trip and break. This method effectively avoids insulation damage to the devices and serious faults caused by the breaking overvoltage of the energy storage circuit breaker due to the capacitive inactive power emitted by the energy storage system when a bus fault occurs.

The method for isolating failure in the alternating current bus of the energy storage power station includes: when a fault occurs on the alternating current bus, controlling all non-energy storage circuit breakers to trip and break and transmitting a protective signal to a coordination controller PMS by a bus protection device; upon receiving the protective signal, controlling all energy storage inverters PCS to perform power regulation and adjusting their power to 0 by the coordination controller PMS; and controlling an energy storage circuit breaker to trip and break, thereby completing isolation of the fault of the alternating current bus; where the energy storage circuit breaker is a vacuum circuit breaker.

In an embodiment, the tripping and breaking of the energy storage circuit breaker is controlled by a step-up substation monitoring system; when the step-up substation monitoring system receives the protective signal from the bus protection device, controlling the energy storage circuit breaker to trip and break after delaying for a preset delay time.

In an embodiment, the tripping and breaking of the energy storage circuit breaker is controlled by an energy management system EMS; when a monitoring host in the energy management system EMS receives the protective signal from the energy storage inverter PCS or the bus protection device, controlling the energy storage circuit breaker to trip and break by the monitoring host after delaying for a preset delay time.

In an embodiment, the tripping and breaking of the energy storage circuit breaker is controlled by the energy management system EMS; when the coordination controller PMS detects that the power of the energy storage inverter PCS is 0, sending an instruction to the monitoring host in the energy management system EMS, and controlling the energy storage circuit breaker to trip and break by the monitoring host.

In an embodiment, the coordination controller PMS transmits data with all the energy storage inverters PCS through a GOOSE network.

In an embodiment, the monitoring host transmits data with the energy storage circuit breaker through an MMS network.

In an embodiment, the preset delay time is 50 ms.

The method for isolating failure in the alternating current bus of the energy storage power station in the present disclosure has the following beneficial effects.

By coordinating the bus protection device and the coordination controller PMS, the present disclosure first controls all non-energy storage circuit breakers to trip and break, and transmits the protective signals to the coordination controller PMS to regulate the power of the energy storage inverter PCS to zero. Then, the energy storage circuit breaker is controlled to trip and break. The present disclosure effectively avoids insulation damage to the devices connected to the alternating current bus and serious faults caused by the breaking overvoltage of the energy storage circuit breaker due to the capacitive inactive power emitted by the energy storage system when a bus fault occurs.

The bus protection device and the coordination controller PMS are both existing structures of the energy storage power station, no additional device is required. Moreover, the vacuum circuit breaker has not been replaced by a higher performance or higher cost circuit breaker (such as an SF6 circuit breaker or a C2-grade vacuum circuit breaker), therefore, the present disclosure is more economical (i.e. low cost).

### BRIEF DESCRIPTION OF DRAWINGS

FIG. 1 is a structural diagram of an energy storage power station in a first embodiment.

FIG. 2 is a structural diagram of an energy storage power station in a second embodiment.

FIG. 3 is a flow chart of a method for isolating failure in an alternating current bus of an energy storage power station in the present disclosure.

### REFERENCE NUMERALS

| | |
|---|---|
| Energy storage circuit breaker | 001 |
| Non-energy storage circuit breaker | 002 |
| Energy storage unit | 1 |
| Energy storage inverter PCS | 11 |
| Energy storage battery pack | 12 |
| Energy storage transformer | 13 |
| Energy management system EMS | 2 |
| Coordination controller | 21 |
| Monitoring host | 22 |
| Bus protection device | 3 |
| Step-up substation monitoring system | 4 |

### DETAILED DESCRIPTION OF THE INVENTION

The following illustrates the embodiments of the present disclosure by means of particular specific examples, and other advantages and efficacies of the present disclosure can be easily understood by those skilled in the art from the contents disclosed in this specification.

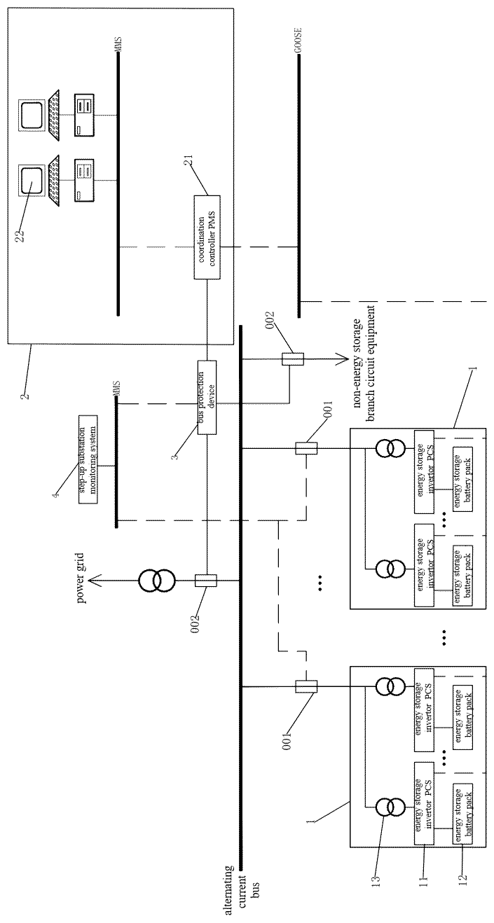

Please refer to FIGS. 1 to 3. It should be noted that the structures, proportions, sizes, etc. depicted in the drawings accompanying this specification are only intended to assist in explaining the content of the specification for the understanding and reading of those familiar with this technology, and are not intended to limit the implementation of the present disclosure, therefore they do not have any technical significance. Any modifications to the structure, changes in proportion relationship, or adjustments in size that do not affect the effectiveness or achievement of the present disclosure should still fall within the scope of the technical content disclosed in the present disclosure. At the same time, terms such as “up”, “bottom”, “left”, “right”, “middle”, “a”, etc. in this specification are used only for the convenience of description and clarity, and are not used to limit the implementation of the present disclosure. Changes or adjustments in relative relationships are also considered to be within the scope of the implementation of the present disclosure without substantial change in technical content.

### Embodiment 1

As shown in FIG. 1, an energy storage power station of this embodiment includes an energy storage system, non-energy storage branch circuit equipment, an energy management system EMS 2, a bus protection device 3, and a step-up substation monitoring system 4. The energy storage system includes at least one energy storage unit 1, and each energy storage unit 1 and the non-energy storage branch circuit equipment are connected in parallel on an alternating current bus. An energy storage circuit breaker 001 is provided on the energy storage branch circuit between each energy storage unit 1 and the alternating current bus, and the energy storage circuit breaker 001 is a vacuum circuit breaker. A non-energy storage circuit breaker 002 is provided on the non-energy storage branch circuit between the non-energy storage branch circuit equipment and the alternating current bus. The alternating current bus is connected to the power grid through a main circuit, and the main circuit is provided with a non-energy storage circuit breaker 002. Each energy storage unit 1 includes an energy storage inverter 11, an energy storage battery pack 12, and an energy storage transformer 13 connected in series. The energy management system EMS 2 includes a coordination controller 21 and a monitoring host 22, where the coordination controller 21 and the monitoring host 22 perform data communication through an MMS network. The bus protection device 3 is connected to the non-energy storage circuit breakers 002, the coordination controller 21, and the step-up substation monitoring system 4. The step-up substation monitoring system 4 is connected to the energy storage circuit breaker 001, and the coordination controller 21 performs data communication with each energy storage inverter PCS 11 through a GOOSE network.

The energy storage circuit breaker 001 is a circuit breaker installed in the energy storage branch circuit, and the non-energy storage circuit breaker is a circuit breaker installed in the main circuit and the non-energy storage branch circuit.

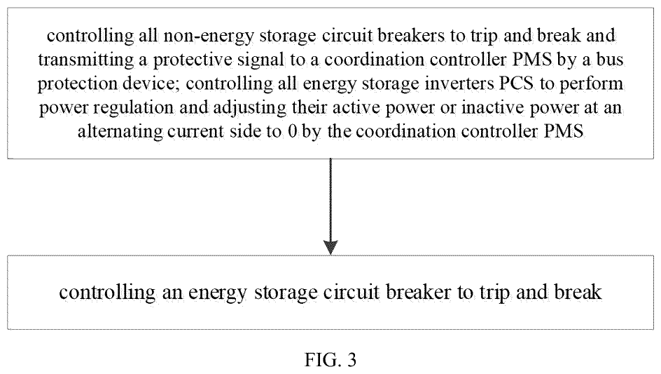

As shown in FIGS. 1 and 3, a method for isolating failure in an alternating current bus of an energy storage power station of this embodiment is realized by the bus protection device 3, the coordination controller 21, and the step-up substation monitoring system 4, where the coordination controller 21 and the step-up substation monitoring system 4 are connected to the bus protection device 3. The method includes the following steps.

When a fault occurs on the alternating current bus, the bus protection device 3 initiates protective actions. On one hand, it controls all non-energy storage circuit breakers 002 to trip and break. On the other hand, it transmits protective signals to the step-up substation monitoring system 4 and the coordination controller PMS 21 in the energy management system EMS 2. Upon receiving the protective signals, the coordination controller PMS 21 sends power regulation commands to all energy storage inverters PCS 11 through the GOOSE network to adjust the power of the energy storage inverters PCS 11 to 0 (i.e., achieving power lockout).

Once receiving the protective signals, the step-up substation monitoring system 4 controls the energy storage circuit breaker 001 to trip and break after delaying for a preset delay time, completing the isolation of the fault of the alternating current bus.

The power regulation of the energy storage inverter PCS 11 specifically refers to the regulation of the output power at the alternating current side of the energy storage inverter PCS 11, which includes the regulation of active power and/or inactive power at the alternating current side.

The preset delay time of the step-up substation monitoring system 4 can be determined by the time required from the bus protection device initiating the protective action to the power of the energy storage inverter PCS 11 turning to 0. The time required from the bus protection device initiating the protective action to the power of the energy storage inverter turning to 0 generally includes a signal transmission time t1, an internal signal delay time t2 of the coordination controller PMS 21 and the energy storage inverter PCS 11, and a time t3 required from the energy storage inverter PCS 11 responding to the command to the power of the energy storage inverter PCS 11 turning to 0. Since the signal transmission rate is at the speed of light, the signal transmission time t1 can be ignored. The internal signal delay time t2 is generally in a range of 4 ms to 10 ms. The time t3 required by the energy storage inverter PCS 11 to execute instruction is usually in a range of 0 ms to 40 ms. Therefore, the time required from the bus protection device initiating the protective action to the power of the energy storage inverter PCS 11 turning to 0 is in a range of 4 ms to 50 ms, and a range of 20 ms to 50 ms is preferred in this embodiment.

In order to prevent the step-up substation monitoring system 4 from controlling the energy storage circuit breaker 001 to trip and break in advance, the preset delay time is at least 50 ms.

### Embodiment 2

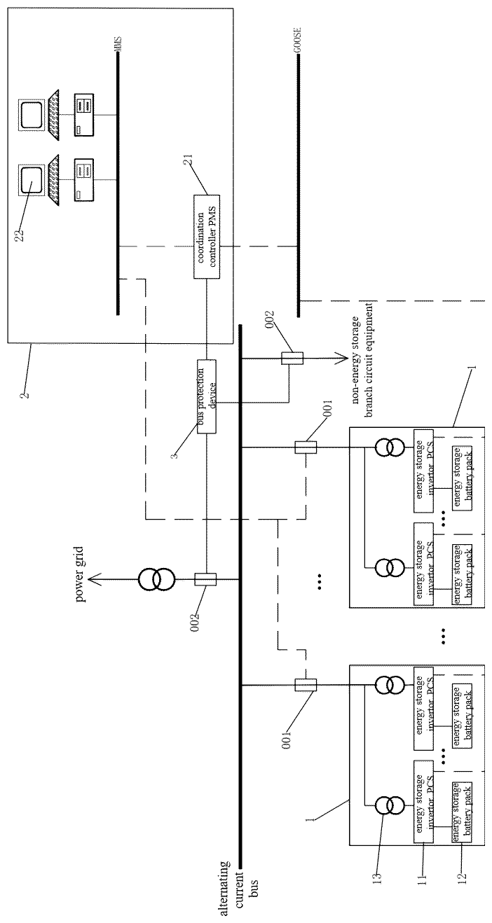

As shown in FIG. 2, an energy storage power station of this embodiment includes an energy storage system, non-energy storage branch circuit equipment, an energy management system EMS 2, and a bus protection device 3. The energy storage system includes at least one energy storage unit 1, and each energy storage unit 1 and the non-energy storage branch circuit equipment are connected in parallel on an alternating current bus. An energy storage circuit breaker 001 is provided on the energy storage branch circuit between each energy storage unit 1 and the alternating current bus, and the energy storage circuit breaker 001 is a vacuum circuit breaker. A non-energy storage circuit breaker 002 is provided on the non-energy storage branch circuit between the non-energy storage branch circuit equipment and the alternating current bus. The alternating current bus is connected to the power grid through the main circuit, and the main circuit is provided with a non-energy storage circuit breaker 002. Each energy storage unit 1 includes an energy storage inverter 11, an energy storage battery pack 12, and an energy storage transformer 13 connected in series. The energy management system EMS 2 includes a coordination controller 21 and a monitoring host 22, where the coordination controller 21 and the monitoring host 22 perform data communication through an MMS network. The bus protection device 3 is connected to the non-energy storage circuit breakers 002 and the coordination controller 21. The coordination controller 21 performs data communication with each energy storage inverter PCS 11 through a GOOSE network.

The energy storage circuit breaker 001 is a circuit breaker installed in the energy storage branch circuit, and the non-energy storage circuit breaker is a circuit breaker installed in the main circuit and the non-energy storage branch circuit.

As shown in FIGS. 2 and 3, a method for isolating failure in an alternating current bus of an energy storage power station of this embodiment is realized by the bus protection device 3 and the coordination controller 21 connected to the bus protection device 3. The method includes the following steps.

When a fault occurs on the alternating current bus, the bus protection device 3 initiates protective actions. On one hand, it controls all non-energy storage circuit breakers 002 to trip and break. On the other hand, it transmits protective signals to the coordination controller PMS 21 in the energy management system EMS 2. Upon receiving the protective signals, the coordination controller PMS 21 then transmits the protective signals to the monitoring host 22 through the MMS network and sends power regulation commands to all energy storage inverters PCS 11 through the GOOSE network to adjust the power of the energy storage inverters PCS 11 to 0 (i.e., achieving power lockout).

Once receiving the protective signals, the monitoring host 22 sends a tripping and breaking command to the energy storage circuit breaker 001 through the MMS network after delaying for a preset delay time to control the tripping and breaking of the energy storage circuit breaker 001, completing the isolation of the fault of the alternating current bus.

The power regulation of the energy storage inverter PCS 11 specifically refers to the regulation of the output power at the alternating current side of the energy storage inverter PCS 11, which includes the regulation of active power and/or inactive power at the alternating current side.

The preset delay time of the monitoring host 22 can be determined by the time required from the bus protection device initiating the protective action to the power of the energy storage inverter PCS 11 turning to 0. The time required from the bus protection device initiating the protective action to the power of the energy storage inverter turning to 0 generally includes a signal transmission time t1, an internal signal delay time t2 of the coordination controller PMS 21 and the energy storage inverter PCS 11, and a time t3 required from the energy storage inverter PCS 11 responding to the command to the power of the energy storage inverter PCS 11 turning to 0. Since the signal transmission rate is at the speed of light, the signal transmission time t1 can be ignored. The internal signal delay time t2 is usually in a range of 4 ms to 10 ms. The time t3 required by the energy storage inverter PCS 11 to execute instruction is usually in a range of 0 ms to 40 ms. Therefore, the time required from the bus protection device initiating the protective action to the power of the energy storage inverter PCS 11 turning to 0 is in a range of 4 ms to 50 ms, and a range of 20 ms to 50 ms is preferred in this embodiment.

In order to prevent the monitoring host 22 from controlling the energy storage circuit breaker 001 to trip and break in advance, the preset delay time is at least 50 ms.

### Embodiment 3

As shown in FIG. 2, an energy storage power station of this embodiment includes an energy storage system, non-energy storage branch circuit equipment, an energy management system EMS 2, and a bus protection device 3. The energy storage system includes at least one energy storage unit 1, and each energy storage unit 1 and the non-energy storage branch circuit equipment are connected in parallel on an alternating current bus. An energy storage circuit breaker 001 is provided on the energy storage branch circuit between each energy storage unit 1 and the alternating current bus, and the energy storage circuit breaker 001 is a vacuum circuit breaker. A non-energy storage circuit breaker 002 is provided on the non-energy storage branch circuit between the non-energy storage branch circuit equipment and the alternating current bus. The alternating current bus is connected to the power grid through a main circuit, and the main circuit is provided with a non-energy storage circuit breaker 002. Each energy storage unit 1 includes an energy storage inverter 11, an energy storage battery pack 12, and an energy storage transformer 13 connected in series. The energy management system EMS 2 includes a coordination controller 21 and a monitoring host 22, where the coordination controller 21 and the energy storage circuit breakers all communicate with the monitoring host 22 through an MMS network. The bus protection device 3 is connected to the non-energy storage circuit breakers 002 and the coordination controller 21. The coordination controller 21 performs data communication with each energy storage inverter PCS 11 through a GOOSE network.

As shown in FIGS. 2 and 3, a method for isolating failure in an alternating current bus of an energy storage power station of this embodiment is realized by the bus protection device 3 and the coordination controller 21 connected to the bus protection device 3. The method includes the following steps.

When a fault occurs on the alternating current bus, the bus protection device 3 initiates protective actions. On one hand, it controls all non-energy storage circuit breakers 002 to trip and break. On the other hand, it transmits protective signals to the coordination controller PMS 21 in the energy management system EMS 2. Upon receiving the protective signals, the coordination controller PMS 21 sends power regulation commands to all energy storage inverters PCS 11 through the GOOSE network to adjust the power of the energy storage inverters PCS 11 to 0 (i.e., achieving power lockout).

After detecting that the power of the energy storage inverters PCS 11 turns to 0, the coordination controller PMS 21 immediately sends an instruction signal to the monitoring host 22 to control the tripping and breaking of the energy storage circuit breaker 001. Once receiving the instruction signal, the monitoring host 22 controls the energy storage circuit breaker 001 to trip and break, completing the isolation of the fault of the alternating current bus.

The power regulation of the energy storage inverter PCS 11 specifically refers to the regulation of the output power at the alternating current side of the energy storage inverter PCS 11, which includes the regulation of active power and/or inactive power at the alternating current side.

### Embodiment 4

Different from Embodiment 2, in this embodiment, the bus protection device 3 further communicates with the monitoring host 22, and the energy management system EMS 2 is an existing system or a system in which the functions of the step-up substation monitoring system 4 are integrated.

When a fault occurs on the alternating current bus, the bus protection device 3 initiates protective actions. On one hand, it controls all non-energy storage circuit breakers 002 to trip and break. On the other hand, it transmits protective signals to the coordination controller PMS 21 and the monitoring host 22 in the energy management system EMS 2. Upon receiving the protective signals, the coordination controller PMS 21 sends power regulation commands to all energy storage inverters PCS 11 through the GOOSE network to adjust the power of the energy storage inverters PCS 11 to 0 (i.e., achieving power lockout).

Once receiving the protective signals, the monitoring host 22 sends a tripping and breaking command to the energy storage circuit breaker 001 through the MMS network after delaying for a preset delay time to control the tripping and breaking of the energy storage circuit breaker 001, completing the isolation of the fault of the alternating current bus.

The power regulation of the energy storage inverter PCS 11 specifically refers to the regulation of the output power at the alternating current side of the energy storage inverter PCS 11, which includes the regulation of active power and/or inactive power at the alternating current side.

The preset delay time of the monitoring host 22 can be determined by the time required from the bus protection device initiating the protective action to the power of the energy storage inverter PCS 11 turning to 0. The time required from the bus protection device initiating the protective action to the power of the energy storage inverter turning to 0 generally includes a signal transmission time t1, an internal signal delay time t2 of the coordination controller PMS 21 and the energy storage inverter PCS 11, and a time t3 required from the energy storage inverter PCS 11 responding to the command to the power of the energy storage inverter PCS 11 turning to 0. Since the signal transmission rate is at the speed of light, the signal transmission time t1 can be ignored. The internal signal delay time t2 is usually in a range of 4 ms to 10 ms. The time t3 required by the energy storage inverter PCS 11 to execute instruction is usually in a range of 0 ms to 40 ms. Therefore, the time required from the bus protection device initiating the protective action to the power of the energy storage inverter PCS 11 turning to 0 is in a range of 4 ms to 50 ms, and a range of 20 ms to 50 ms is preferred in this embodiment.

In order to prevent the monitoring host 22 from controlling the energy storage circuit breaker 001 to trip and break in advance, the preset delay time is at least 50 ms.

### Embodiment 5

Different from Embodiments 1 to 4, in this embodiment, when the power of the energy storage inverter PCS 11 turns to 0, the energy storage circuit breaker 001 is controlled manually to trip and break, thus completing the isolation of the fault of the alternating current bus.

In summary, the present disclosure effectively overcomes the technical problem of insulation damage to devices and serious faults caused by the breaking overvoltage of the energy storage circuit breaker due to the capacitive inactive power emitted by the energy storage system when a bus fault occurs. The bus protection device and the coordination controller PMS are both existing structures of the energy storage power station, therefore, no additional device is required. Moreover, the vacuum circuit breaker has not been replaced by a higher performance or higher cost circuit breaker, therefore, the present disclosure is more economical (i.e. low cost).

The above embodiments are only exemplary to illustrate the principle of the present disclosure and its effectiveness, and are not intended to limit the present disclosure. Any person familiar with the art may modify or change the above embodiments without violating the spirit and scope of the present disclosure. Therefore, all equivalent modifications or changes made by persons having ordinary knowledge of the art without departing from the spirit and technical ideas disclosed in the present disclosure shall still be covered by the claims of the present disclosure.

1. A method for isolating failure in an alternating current bus of an energy storage power station, comprising:
when a fault occurs on the alternating current bus,
controlling all non-energy storage circuit breakers to trip and break and transmitting a protective signal to a coordination controller PMS by a bus protection device; upon receiving the protective signal, controlling all energy storage inverters PCS to perform power regulation and adjusting power of the energy storage inverters PCS to 0 by the coordination controller PMS; and
controlling an energy storage circuit breaker to trip and break, thereby completing isolation of the fault of the alternating current bus; wherein the energy storage circuit breaker is a vacuum circuit breaker.

2. The method according to claim 1, wherein the controlling of the energy storage circuit breaker to trip and break is realized by a step-up substation monitoring system; when the step-up substation monitoring system receives the protective signal from the bus protection device, controlling the energy storage circuit breaker to trip and break after delaying for a preset delay time.

3. The method according to claim 1, wherein the controlling of the energy storage circuit breaker to trip and break is realized by an energy management system EMS; when a monitoring host in the energy management system EMS receives the protective signal from the coordination controller PMS or the bus protection device, controlling the energy storage circuit breaker to trip and break by the monitoring host after delaying for a preset delay time.

4. The method according to claim 1, wherein the controlling of the energy storage circuit breaker to trip and break is realized by an energy management system EMS; when the coordination controller PMS detects that the power of the energy storage inverter PCS is 0, sending an instruction to a monitoring host in the energy management system EMS, and controlling the energy storage circuit breaker to trip and break by the monitoring host.

5. The method according to claim 1, wherein the coordination controller PMS transmits data with all the energy storage inverters PCS through a GOOSE network.

6. The method according to claim 3, wherein the monitoring host transmits data with the energy storage circuit breaker through an MMS network.

7. The method according to claim 2, wherein the preset delay time is 50 ms.

8. The method according to claim 2, wherein the coordination controller PMS transmits data with all the energy storage inverters PCS through a GOOSE network.

9. The method according to claim 3, wherein the coordination controller PMS transmits data with all the energy storage inverters PCS through a GOOSE network.

10. The method according to claim 4, wherein the coordination controller PMS transmits data with all the energy storage inverters PCS through a GOOSE network.

11. The method according to claim 4, wherein the monitoring host transmits data with the energy storage circuit breaker through an MMS network.

12. The method according to claim 3, wherein the preset delay time is 50 ms.
